(19) United States
(12) Patent Application Publication
(10) Pub. No.: US 2010/0017741 A1
(43) Pub. Date: Jan. 21, 2010

(54) START OF AN APPLICATION FROM AN IDLE STATE DISPLAY MODE OF A MOBILE TERMINAL

(75) Inventors: Ville Samuli Karp, Halikko (FI); Jeroen Jacob Van Rijn, San Diego, CA (US)

Correspondence Address: Perman & Green, LLP, 99 Hawley Lane, Stratford, CT, 06614, US

(73) Assignee: NOKIA CORPORATION, Nokia Group (FI)

(21) Appl. No.: 12/174,048

(22) Filed: Jul. 16, 2008

(51) Int. Cl. G06F 3/048

(52) U.S. Cl. 715/780

(57) ABSTRACT

A method of performing input to an application, a mobile terminal for performing input to an application and a user interface for performing input to an application. The method including receiving in a display being in an idle state display mode a first character of an information item associated with the application and displaying an input field and the first character in the input field on the display in response to the received first character, receiving more characters to the input field the received more characters following the received first character so as to complete the information item, invoking the application using the completed information item as an input parameter to the application, wherein the application is selected from a group including a navigation application, an application for adding or updating contacts who can be phoned, an application for sending SMS, and an application applying a letter in the completed information item.

### FIELD

The disclosed embodiments generally relate to a method of performing input to an application, a mobile terminal for performing input to an application and a user interface for performing input to an application.

### BACKGROUND

For a user of a cellular phone it is common to simply enter a phone number via the ITU keyboard in an idle state display mode of the phone prior to dialing the phone number entered.

The way of operating the phone dates back to the time where a phone was a device which was solely applied to dial up the phone number, e.g. by repeated operation of the finger holes of a dial, in order to call up another phone on the public switched telephone network.

Even nowadays people applying modern cellular phone expect their cellular phone being instantly ready for basically calling up, i.e. ready for receiving the telephone number. However, since modern cellular phones are configured with many functions they normally return—after the application of one of the many functions—to an idle mode, the so called idle state display mode.

The idle state display mode is the starting and finishing point for all tasks associated with a mobile phone; whether making a call, sending a text, checking to see if a SMS or a voicemail has arrived or downloading a ring tone, the idle state display mode precedes and concludes the user journey involved in performing each of these tasks. Most typically the idle state display mode is the mode where an application is running ready to receive a phone number via the ITU keyboard prior to making a call. Accordingly, when the cellular phone is the idle state display mode the cellular phone typically only accepts numerical inputs, i.e. the digits for the phone number to be dialed and subsequently called to.

In the prior art, when a navigation application is to be running location data is often transferred to a navigational device, e.g. a cellular phone, via different kinds of messages. It's thus quite difficult for the user to transfer the location data from the message to the navigation application. At the moment, in the prior art, there are two ways to transfer addresses from a message to the navigation application: The first way is to write the address down on a piece of a paper and then manually input the address data to the maps application, which—in the terms of the applicant company—is the navigation application. Another way is to open the received message in an text editor and from there on copy paste the location data to the navigation application. This is of course rather cumbersome and inconvenient for the user and thus calls for a better way of supplying the address to the navigation application prior to the launch of the navigation application.

A user of a modern multifunctional cellular phone also apply his cellular phone to send SMS, i.e. text messages, which text messages of course need be entered prior to sending, thus textual input is to be entered before the SMS can be send.

Further, the user of the modern multifunctional cellular phone also uses his cellular phone, when equipped with GPS functionality, to navigate to a certain destination, where the destination may be entered as an address, i.e. a street name, a street number, a city name, a zip code for the area and the country, thus some kind of textual input including digits are required to tell the cellular phone where to navigate to.

Moreover, the user of the cellular phone does not always want to key in a sequence of digits when calling somebody, thus the user of course wants to avoid to enter a phone number via the keyboard prior to making a call, at least for the second time when the same contact is called. To avoid this cumbersome entering of digits each time a call is made number, the user instead maintains a database with a list of contacts. Thus to maintain the list of contacts of the database occasionally some kind of textual input—including digits for the phone number—are required to be entered.

For a user desiring to launch any of the three above mentioned applications, i.e. the application of sending a SMS, navigating and entering and/or updating his list of contacts he will experience that such application cannot directly be performed from the idle state display mode of the prior art phones since the idle state display mode of such phones only accepts either digits associated with a telephone number or a selection from a menu.

Thus the user cannot from the idle state display mode of a prior art phone enter textual input—being the input date for the application to be invoked—prior to either sending of a SMS, navigating, entering and updating his list of contacts since basically the cellular phone only accepts digits, and not letters, when in the idle screen display mode. Accordingly, the user has to when he wants to—and when he apply a prior art phone—either send an SMS, navigate or to modify his list of contacts in the first place, as the first step, make a choice from a menu selection to do so, i.e. to invoke a specific application where after the textual input representing the SMS, the navigational address or the new/updated contact is to be keyed in.

Thus the user interface at present of the prior art cellular phone, which user interface typically has an ITU keyboard for inputs and to invoke a specific application, is awkward and requires many steps and keystrokes.

Consequently, there is a need for an improved user interface to manage the invocation of applications requiring typical textual input when the cellular phone—as in the prior art—only is primarily expected to be able to receive a phone number when in the idle screen display mode.

The advantage of the scenarios described below is that e.g. starting of a navigation application; a SMS sending application or a contacts application is easier and faster for the end user. The user doesn't have to launch e.g. the navigation application first and then have to wait for loading the corresponding software and the time for finding satellites before he is allowed and able to input the navigation target address. According to the disclosed embodiments he can simply enter the navigation target address when in the idle state display mode and thereafter launch the navigation application with a minimum number of steps and thus with a minimum number of keystrokes and accordingly with a minimum amount of user interaction.

Thus it is an object of the disclosed embodiments to enable the user to enter text input as well as numerical input when the cellular phone in the idle state display mode prior to that the application actually using the input as its input parameter is invoked.

### SUMMARY

In view of the above, the disclosed embodiments is to make it easier to start an application requiring a text input from the idle state display mode and to render it easier to start an application from a mobile terminal. Accordingly, to the aspect of the disclosed embodiments provide user interface from which it is easy to start an application requiring a text input when the display of the user interface is in the idle state display mode.

According to a first aspect of the disclosed embodiments there has been provided a method of performing input to an application comprising:

receiving in a display being in an idle state display mode a first character of an information item associated with the application and displaying an input field and said first character in said input field on said display in response to said received first character,

receiving more characters to said input field said received more characters following said received first character so as to complete said information item,

invoking the application using said completed information item as an input parameter to the application, wherein said application is selected from a group comprising a navigation application, an application for adding or updating contacts who can be phoned, an application for sending SMS, and an application applying a letter in said completed information item.

In an embodiment said completed information item selected from the group of a phone number, a set of GPS coordinates, a contact information, an address or a phone number included in a SMS message and a postal address of the location to navigate to, when said application being a navigation application.

In an embodiment said completed information item being a contact information such as a name and a phone number of a contact and when said application being an application for adding or updating contacts who can be phoned.

In an embodiment said completed information item being a SMS message when said application being an application for sending SMS.

In an embodiment the characters received are handled by a predictive text application so as to complete said information item before all characters comprised in the complete information item are received.

In an embodiment said predictive text application being selected from the group of t9 and xt9.

In an embodiment said characters received from an ITU keyboard.

In an embodiment the characters received are transferred from another application.

In an embodiment the action of transferring comprising the step of cutting and pasting a text from another application.

In an embodiment the action of transferring comprising the step of copying and pasting text from another application.

According to a second aspect of the disclosed embodiments there has been provided a mobile terminal for performing input to an application comprising

an application handler for handling said application,

a display in an idle state display mode,

a man-machine interface for receiving a first character of an information item associated with the application while said display is an idle state display mode,

the display for displaying an input field and said first character in said input field in response to said received first character,

said input field for receiving more characters following said first character from said man machine interface, said received more characters following said received first character so as to complete said information item,

said application handler for invoking the application using said completed information item as an input parameter to the application, wherein said application is selected from a group comprising a navigation application, an application for adding or updating contacts who can be phoned, an application for sending SMS, and an application applying a letter in said completed information item.

In an embodiment said completed information item selected from the group of a phone number, a set of GPS coordinates, a contact information, an address or a phone number included in a SMS message and a postal address of the location to navigate to, when said application being a navigation application.

In an embodiment said completed information item being a contact information such as a name and a phone number of a contact when said application being an application for adding or updating contacts who can be phoned.

In an embodiment said completed information item being a SMS message when said application being an application for sending SMS.

In an embodiment said received characters being handled by a predictive text application for completing said information item before all characters comprised in the complete information item are received.

In an embodiment said predictive text application being selected from the group of t9 and xt9.

In an embodiment said man-machine interface comprising an ITU keyboard for receiving said characters.

In an embodiment said received characters being transferred from another application.

In an embodiment said action of transferring comprising the step of cutting and pasting a text from another application.

In an embodiment said action of transferring comprising copying and pasting text from another application.

According to a third aspect of the disclosed embodiments there has been provided a user interface for performing input to an application comprising

an application handler for handling said application,

a display in an idle state display mode,

a man-machine interface for receiving a first character of an information item associated with the application while said display is an idle state display mode,

the display for displaying an input field and said first character in said input field in response to said received first character,

said input field for receiving more characters following said first character from said man machine interface, said received more characters following said received first character so as to complete said information item, and

said application handler for invoking the application using said completed information item as an input parameter to the application, wherein said application is selected from a group comprising a navigation application, an application for adding or updating contacts who can be phoned, an application for sending SMS, and an application applying a letter in said completed information item.

In an embodiment said completed information item selected from the group of a phone number, a set of GPS coordinates, a contact information, an address or a phone number included in a SMS message and a postal address of the location to navigate to, when said application being a navigation application.

In an embodiment said completed information item being a contact information such as a name and a phone number of a contact when said application being an application for adding or updating contacts who can be phoned.

In an embodiment said completed information item being a SMS message when said application being an application for sending SMS'es.

In an embodiment said received characters being handled by a predictive text application for completing said information item before all characters comprised in the complete information item are received.

In an embodiment said predictive text application being selected from the group of t9 and xt9.

In an embodiment said man-machine interface comprising an ITU keyboard for receiving said characters.

In an embodiment said received characters being transferred from another application.

In an embodiment said action of transferring comprising the step of cutting and pasting a text from another application.

In an embodiment said action of transferring comprising copying and pasting text from another application.

According to a fourth aspect of the disclosed embodiments there has been provided a computer program product comprising software instructions that, when executed in a controller of a mobile terminal, performs the method according to the first aspect

Other objectives, features and advantages of the disclosed embodiments will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, device, terminal, component, means, step, etc” are to be interpreted openly as referring to at least one instance of the element, device, terminal, component, means, step, etc., unless explicitly stated otherwise.

### BRIEF DESCRIPTION OF THE DRAWINGS

Embodiments will now be described in more detail, reference being made to the enclosed drawings, in which:

FIG. 1 is a schematic illustration of a cellular telecommunication system, as an example of an environment in which the disclosed embodiments may be applied.

FIG. 2 is a schematic front view illustrating a mobile terminal according to an embodiment.

FIG. 3 is a schematic block diagram representing an internal component, software and protocol structure of the mobile terminal shown in FIG. 2.

FIG. 3a shows an ITU keyboard.

FIGS. 4-13 illustrate schematic screen views of a user interface that can be embodied in the mobile terminal of FIG. 2.

FIGS. 14, 15 and 16 are three flow charts illustrating methods of navigating, sending a SMS and adding or updating a contact to contacts, respectively according to three embodiment that can be executed in the mobile terminal of FIG. 2.

### DETAILED DESCRIPTION OF EMBODIMENTS

Embodiments will now be described more fully hereinafter with reference to the accompanying drawings, in which certain embodiments are shown. These disclosed embodiments may, however, be embodied in many different forms and should not be construed as limited to the embodiments set forth herein; rather, these embodiments are provided by way of example so that this disclosure will be thorough and complete, and will fully convey the scope of the disclosed embodiments to those skilled in the art. Like numbers refer to like elements throughout.

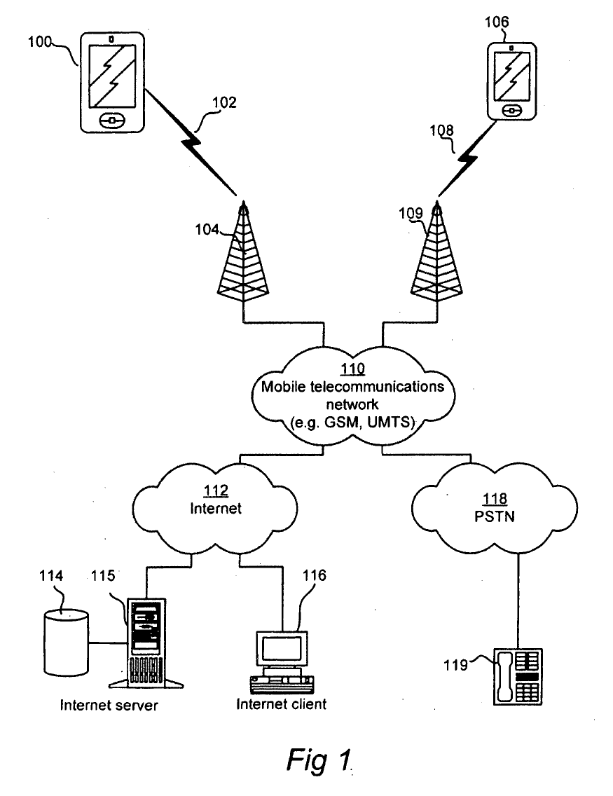

FIG. 1 illustrates an example of a cellular telecommunications system in which the disclosed embodiments may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between a mobile terminal 100, according to some embodiments of the disclosed embodiments and other devices, such as another mobile terminal 106 or a stationary telephone 119. It is to be noted that for different embodiments of the mobile terminal 100 and in different situations, different ones of the telecommunications services referred to above may or may not be available; the disclosed embodiments are not limited to any particular set of services in this respect.

The mobile terminals 100, 106 may be connected to a mobile telecommunications network 110 through radio frequency (RF) links 102, 108 via base stations 104, 109. The mobile telecommunications network 110 may be in compliance with any commercially available mobile telecommunications standard, such as Global System Mobile (GSM), Universal Mobile Telecommunications System (UMTS), Digital-Advanced Mobile Phone Service (D-AMPS), Code Division Multiple Access2000 (CDMA2000), (Freedom of Mobile Multimedia Access) FOMA and Time Division-Synchronous Code Division Multiple Access (TD-SCDMA). The mobile telecommunications network 110 may be operatively connected to a wide area network 112, which may be Internet or a part thereof. A server 115 may have data storage 114 and may be connected to the wide area network 112, as is an Internet client computer 116.

A public switched telephone network (PSTN) 118 may be connected to the mobile telecommunications network 110. Various telephone terminals, including the stationary telephone 119, may be connected to the PSTN 118. In an embodiment the phone number may be either a cellular phone number or number of a phone connected to the public switched telephone network.

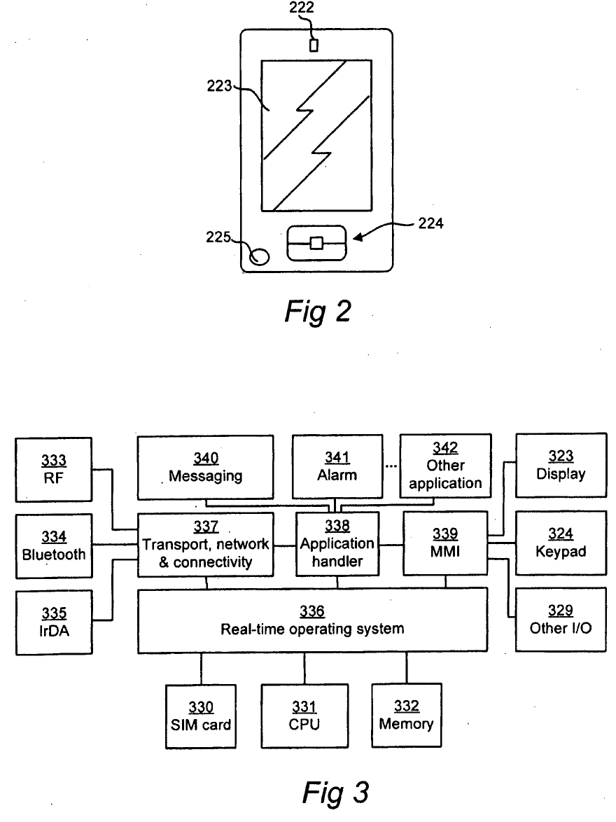

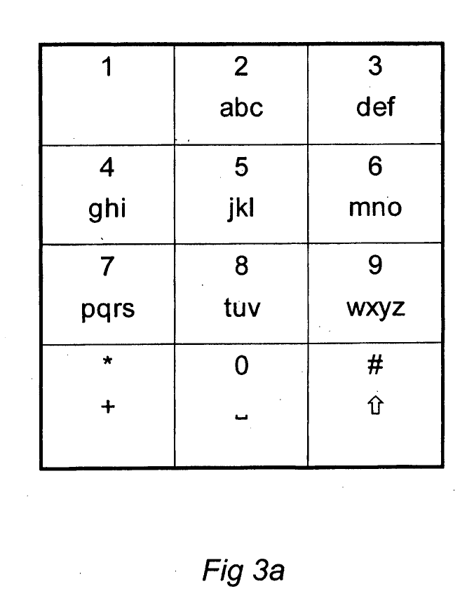

An embodiment 200 of the mobile terminal 100 is illustrated in more detail in FIG. 2. The mobile terminal 200 comprises a speaker or earphone 222, a microphone 225, a touch-sensitive or an ordinary display 223 and a set of keys 224 of e.g. an ITU keyboard, see FIG. 3a.

A possible internal structure of the mobile terminal 100 will now be described with reference to FIG. 3. A controller 331, may be responsible for the overall operation of the mobile terminal 100 and may preferably, but not necessarily, be implemented by any commercially available CPU (“Central Processing Unit”), DSP (“Digital Signal Processor”) or any other electronic programmable logic device. The controller 331 may have associated electronic memory 332 such as RAM memory, ROM memory, EEPROM memory, flash memory, hard drive, and optical storage or any combination thereof. The memory 332 may be used for various purposes by the controller 331, one of them being for storing data and program instructions for various software in the mobile terminal. The software may include a real-time operating system 336, drivers for a man-machine interface (MMI) 339, an application handler 338 as well as various applications. The MMI interface in conjunction with the application handler 338 handle invoking of satellite navigation application using the Global Positioning System (GPS) 343, invoking an application for sending of SMS and invocation of two applications for updating, adding contacts to a contacts application, respectively after input, typically text such as letters and digits, were received in an idle state display mode according to an embodiment prior to the launch of the above mentioned respective four applications. The MMI interface may include the ITU keyboard for receiving the abovementioned input.

The applications may include a messaging application 340, an alarm application 341, as well as various other applications 342, such as applications for voice calling, video calling, web browsing, media player, SMS sending and receiving, navigational application, document reading and/or document editing, an instant messaging application, a contacts update or entering such as in a phone book application, a calendar application, a control panel application, one or more video games, a notepad application, etc.

The MMI 339 may include one or more hardware controllers, which together with the MMI drivers may cooperate with the display 323/223, keypad 324/224, as well as various other I/O devices 329 such as microphone, speaker, vibrator, ring tone generator, LED indicator, etc. As is commonly known, the user may operate the mobile terminal through the man-machine interface thus formed, e.g. an input field is displayed for receiving input(s).

The software may include various modules, protocol stacks, drivers, etc., which are commonly designated as 337 and which may provide communication services (such as transport, network and connectivity) for an RF interface 333, and a Bluetooth interface 334 and/or an IrDA interface 335 for local connectivity. Optionally, a camera is provided. The RF interface 333 may comprise an internal or external antenna as well as appropriate radio circuitry for establishing and maintaining a wireless link to a base station (e.g., the link 102 and base station 104 in FIG. 1). As is well known to a person skilled in the art, the radio circuitry may comprise a series of analogue and digital electronic components, together forming a radio receiver and transmitter. These components may include, i.e., band pass filters, amplifiers, mixers, local oscillators, low pass filters, AD/DA converters, etc.

The mobile terminal may also have a SIM card 330 and an associated reader. As is commonly known, the SIM card 330 may comprise a processor as well as local work and data memory for e.g. the contacts, i.e. telephone number for companies and persons of which the user regularly phone.

FIG. 3a shows an embodiment of an ITU keyboard 301 of the disclosed embodiments. A UK English ITU is shown here but other embodiments may have other characters. The relationships between the letters and the digits on a ITU-T type keypad (alpha-numerical keypad) follows the recommendation of the International Telecommunication Union (ITU) (E.161 02/01 “Arrangement of digits, letters and symbols on telephones and other devices that can be used for gaining access to a telephone network”). The most common system of text input using an ITU-T type keypad is referred to as “multi-tap”. Using multi-tap, a key is pressed multiple times to access the list of letters on that key. For instance, pressing the “2” key 302 once displays an “a”, twice displays a “b” and three times displays a “c”. To enter two successive letters that are on the same key, the user must either pause or hit a “next” button (not shown).

If—as an example—the user wants to enter USA he needs to press the following keys:

8877772

The first press on the key 303 having the text ‘8tuv’ selects T the next press on the button selects U.

The first press on the key 304 having the text ‘7pqrs’ selects P the fourth press on it selects S.

The press on the key 302 having the text 2abc selects the A. Thus by keying on the digit buttons 8877772 USA is entered. The ITU keyboard 301 is well known in the art and will not be explained further.

Now follows scenarios presenting ways of operating a user interface according to various embodiments. Several icons or text, such as time, date, battery level or other icons often seen on communication terminals appear on the figures but is not discussed in further detail.

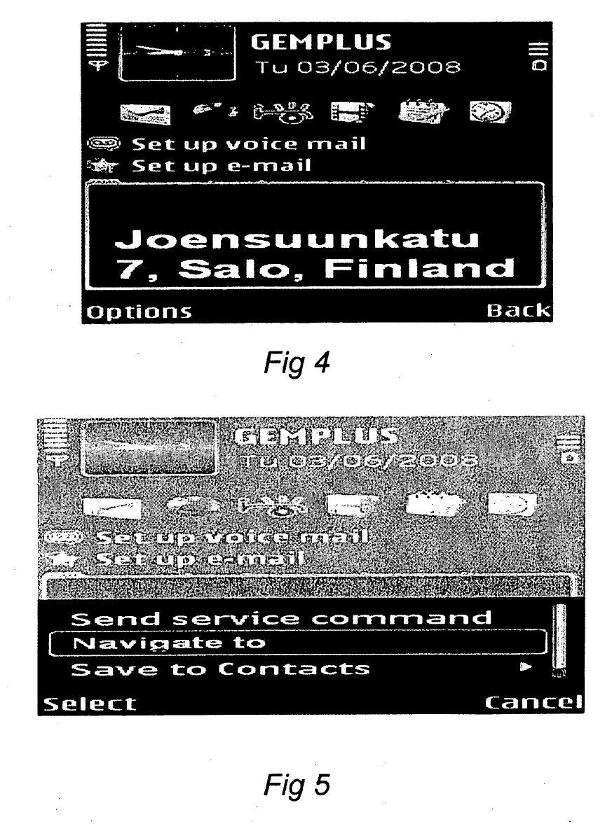

In FIG. 4 an idle state display 400 is where the user inputs the street address where she/he wishes to navigate to. From the idle state display mode the user has entered the address to navigate to. When the first character 402, e.g. the first letter of the address, is received an input field 401 is displayed. The input field 401 displays the first character 402, J as shown, and the following characters as well, i.e. Joensuukatu 7, Salo, Finland. Thus the characters which can be received are a combination of letters and digits, e.g. alphanumerical characters. Subsequently the user selects “Options” 403.

In FIG. 5 the options menu 501 opens and then the user selects the option “Navigate to” 502 which invokes the navigation application with the given street address and country name—as shown in FIG. 4—as the input parameter for the navigation application. After the navigation application 1301 has been launched (see FIG. 13), the navigation application 1301 will start to navigate to the corresponding address, i.e. Joensuukatu 7, Salo, Finland, which address was a end point entered in the idle state display mode. As a final result and the end goal for the user, the user will be presented with a display format as illustrated in FIG. 13. The address the user wishes to navigate to may not need to be entered in an idle state display mode. It may also be entered or input somewhere else, such as in a contacts or phone book application, or received from a business card that has been scanned in by the user.

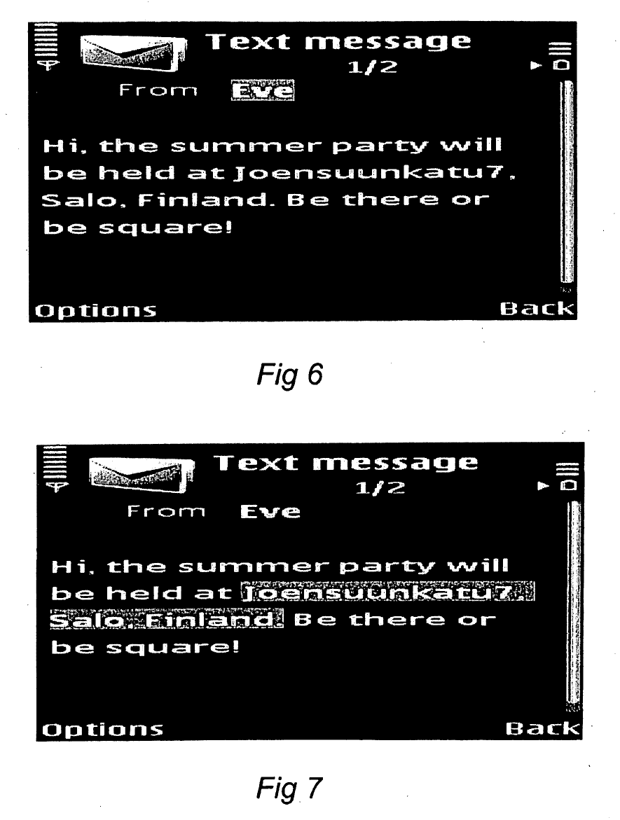

FIGS. 6 to 8 show an embodiment where the user can highlight a street address from any message received, e.g. from within an SMS received, and then invoke the navigation application by selecting Options and Navigate to. In FIG. 6 a received SMS 601 from sender Eve 602 is shown. Sender Eve 602 has been highlighted. In FIG. 7 shows the received SMS 601 as well, but where the address 701 has been highlighted. The highlighting could be done automatically by comparing each word in a message to local town/country database.

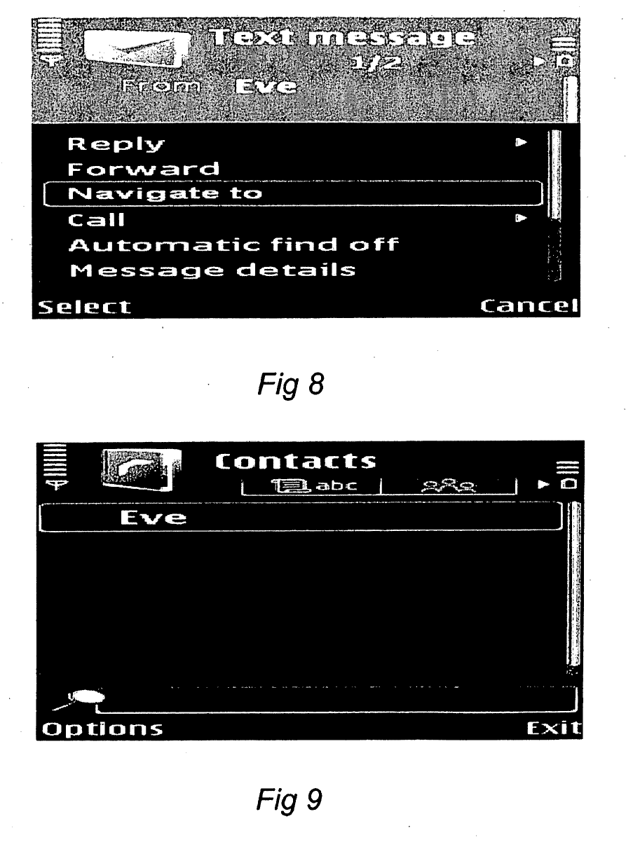

In FIG. 8 the user has received a SMS, which SMS includes, a street address, and the street address has been highlighted. The user subsequently selects “Options” 702—see FIG. 7—by pressing the left soft key and then selects the option of “Navigate to” 801 which in turn invokes the navigation application 1301 (see FIG. 13) with the highlighted street address, city and country as a the input parameter for the invoked navigation application 1301. After the navigation application 1301 has been launched, the navigation application 1301 starts to navigate to the corresponding address highlighted in the SMS. As a result the user will be presented with a display format as illustrated in FIG. 13.

In an embodiment the user highlights the street address, city name and name of country by pressing the down arrow (not shown). The location data field will thereby be highlighted automatically. In a similar way highlighting could mark numbers and/or e-mail addresses.

FIG. 9 shows a contacts application 900 in a main view. The person, i.e. the contact “Eve” 901, has her address field defined meaning her address is stored in a memory in the communication terminal. The address field is associated with her name. Likewise, her telephone number is associated with her name; further see FIG. 11 for her exacts contact details 1101.

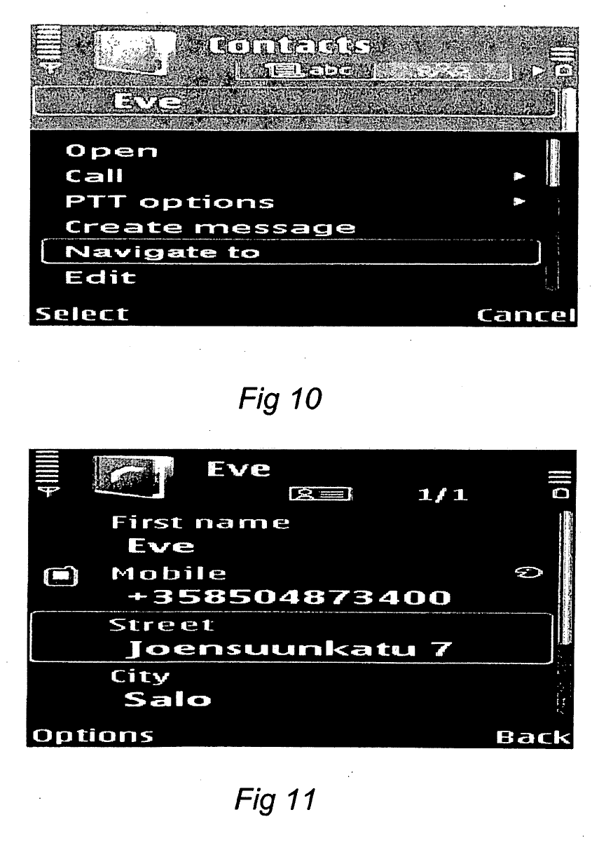

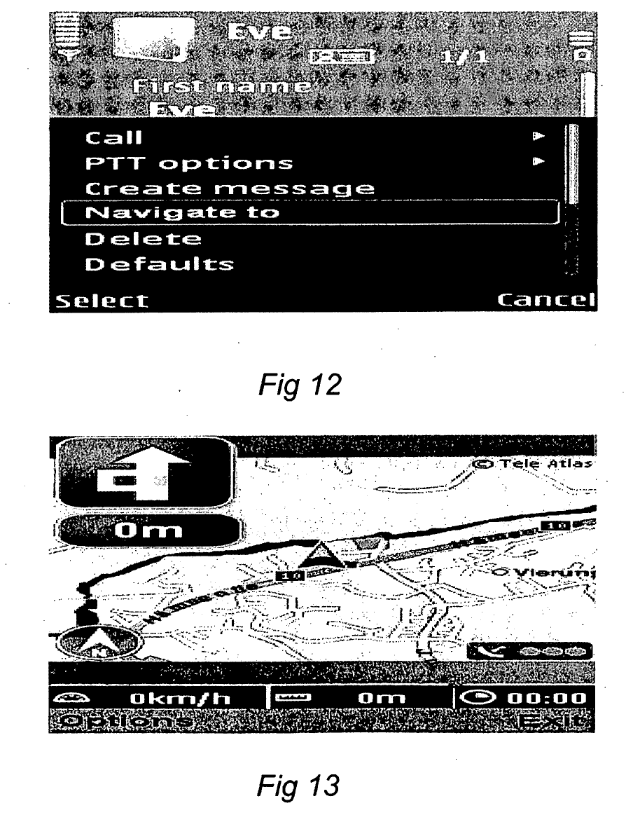

As is well known in the art a contacts application typically has defined several address fields. The contacts application maintains a database having memory space for several contacts. Each contact may comprise address, city and country information in the respective fields, and optionally includes the telephone number(s) for the contact. If the address field, city and country field have been defined, i.e. contain information, a navigation application could be invoked from within the contacts application. It may not be required to fill in country information since the communication terminal may have automatic recognition of the phone number, if available, from the country code or the communication terminal may consider all addresses entered to belong to the country where the communication terminal is registered. The registration is e.g. associated with the carrier, operator, GPS coordinates, clock settings or as a default country setting unless anything else is entered. There are two possibilities: as a first case of choosing “Navigate to” from the contacts application's 900 main view, see FIG. 10, or choose “Navigate to” from a single contact's view 1200 as is illustrated in FIG. 12.

From an implementation point of view this should be possible to implement for a software programmer: the data defined in the address, city and country fields are somehow picked, i.e. cut or copied, and then passed, e.g. pasted, over to the navigation application as a starting input parameters as where to navigate to.

FIG. 10 show the display view when the user has selected “Options”—visible on the previous figure—by means of left soft key and there after selects option “Navigate to”. The latter selection invokes the navigation application with the predefined address as the input parameter. In the specific embodiment shown the predefined address is where Eve has her home. After the navigation application has been launched, the navigation application will start to navigate to the Eves address as was defined in the contact information for her. The defined contact address is shown in FIG. 11 from which it appears that Eve lives on Joensuunkatu 7 in Salo and that the mobile number associated with her is +358504873400.

As shown in FIG. 12 the user subsequently may select “Options” by pressing down the left soft key and there after may select the option of “Navigate to”. The later selection invokes the navigation application 1301 with the Eves address, i.e. “Joensuunkatu 7, Salo”, as the input parameter.

FIG. 13 show the outcome of the launched navigation application 1301 as presented on the display on the cellular phone.

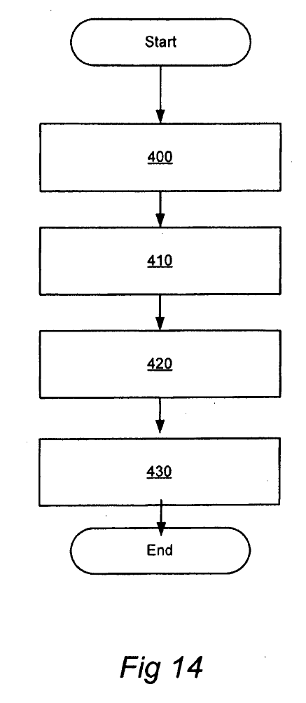

FIG. 14 is a flow chart illustrating a method of navigating according to an embodiment that can be executed in the mobile terminal of FIG. 2. This method corresponds to the scenario disclosed above in conjunction with FIGS. 4-13.

The method of performing input to a navigational application comprising the following steps:

In step 400, while the cellular phone is in the idle state display mode, the user enters the first character, e.g. the first letter of a street name, on which he wants to navigate to.

In step 410, in a response to the entered first character, namely as exemplified the first letter of the street name of the city to navigate to, the cellular phone, by means of the software implemented in the Man Machine Interface, MMI, displays an input field, e.g. a frame, a rectangle or other ways of indicating that the cellular phone now is in a state where it appears to accept further input into the frame or rectangle, etc. In the input field, the first character is then displayed so that the user can see what has been entered.

In step 420, the idea is that then further characters representing the address to navigate to is to be entered in the input field so as to complete the address to navigate to. Practically speaking, three options are available:

The user is required manually to enter, typically key in full address information, i.e. street name, street number, zip code, city and country. As an option the city may be derived from the zip code, and as a further option, the country is derived as the country where the user previously was navigating, the latter is by the applicant company considered as a qualified guess, unless the holder of the cellular phone travels and navigates in various countries regularly.

Some kind of clever predictive text application, e.g. t9 or xt9, completes automatically the character input after a few characters have been entered by the user and presents a proposal or proposals for where to navigate to, namely the postal address, in terms of a street name, a street number, a zip code, a city and country.

Database Lookup

Finally the user can see what has been entered or which proposal has been chosen from the proposal(s) from the predictive text application.

Alternatively, the user could have entered a phone number or a set of GPS coordinates by means of the above-mentioned steps. Further as an alternative the user could somehow, e.g. from a cut and copy or paste operation, have entered either a contact information, e.g. an address or a phone number while keying in characters so as more speedily ending the input sequence.

Further, the address or the phone number could previously have been included in a SMS message and cut and copied or pasted there from into the input field while presented for input. Accordingly, the cellular phone now holds a complete information item in the input field, which item represents where to navigate to.

In step 430, the user then invokes, i.e. starts or launches a navigational application. The navigational application uses the completed information item, e.g. a postal address of the location to navigate to, as an input parameter to the navigational application. The navigational application might apply either the postal address, or the phone number so as to determine a set of GPS coordinates to navigate to. Alternatively, the set of GPS coordinates, the contact information, the address or the phone number as e.g. included in a SMS message are simply keyed into the input field or transferred from the SMS message into the input field. Accordingly, the characters, which were inputted to the input field, are input data to the navigational application prior to the launch, start or invocation thereof.

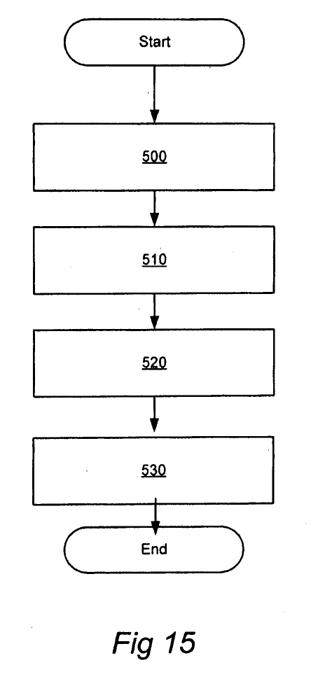

FIG. 15 is a flow chart illustrating a method of entering a SMS according to an embodiment that may be executed in the mobile terminal of FIG. 2. This method corresponds to the scenario disclosed above in conjunction with FIGS. 4-13.

The method of performing input to a SMS sending application comprising the following steps:

In step 500, ; the user enters the first character, i.e. the first character of the SMS, which he wants to send to somebody. The cellular phone may be in the idle state display mode.

In step 510, in a response to the entered first character, typically the first letter of the SMS, the cellular phone, by means of the software implemented in the Man Machine Interface, MMI, displays an input field, e.g. a frame, a rectangle or other ways of indicating that the cellular phone now is in a state where it appears to accept further inputs in the frame or rectangle, etc. In the input field the first character is then displayed so that the user can see what has been entered as the starting character of the SMS and that the input field is ready to receive more characters.

In step 520, further characters representing the SMS are to be entered in the input field so as to complete the SMS. Practically speaking, two options are possible for the user:
1.) Completing, i.e. manually keying in the rest of the each of the words of the SMS, which words are needed to compose the complete SMS message.
2.) Some kind of clever predictive text application, e.g. t9 or xt9, completes automatically each of the words after a few characters of each of the respective words have been entered by the user and predictive text application presents a proposal or proposals for words to be selected and thus actually entered as parts of the SMS.

Further, a text string from a previously received SMS could have been cut, and copied or pasted into the input field while the SMS is being entered or predicted.

Accordingly, the cellular phone now holds and displays a complete string in the input field, which string represents the SMS actually entered or composed as discussed above.

In step 530, the user invokes, i.e. starts or launches a SMS sending application. The SMS sending application uses the completed string as the input parameter to the SMS sending application, i.e. the characters as actually directly inputted and/or pasted to the input field are input data to the SMS sending application prior to its launch, start or invocation.

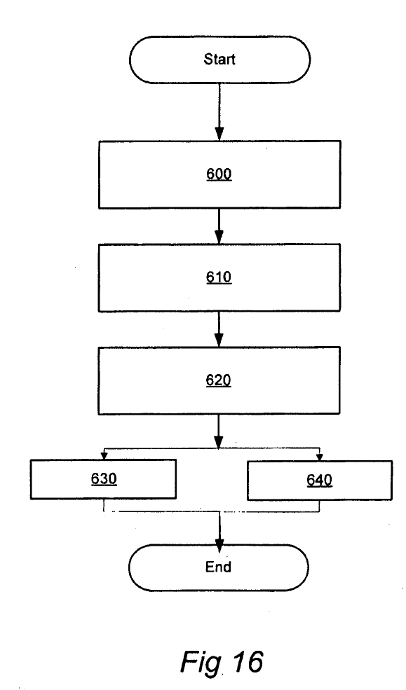

FIG. 16 is a flow chart illustrating a method of updating or entering a contact to contacts according to an embodiment that can be executed in the mobile terminal of FIG. 2. This method corresponds to the scenario disclosed above in conjunction with FIGS. 4-13.

The method of performing input to a contact application for updating or entering a contact to contacts comprising the following steps:

In step 600, while the cellular phone may be in the idle state display mode, the user enters the first character, typically the first letter of the contact, which he either wants to update or enter as a new contact.

In step 610, in a response to the entered first character, the cellular phone displays, by means of the software implemented in the Man Machine Interface, MMI, an input field, e.g. a frame or a rectangle so as to indicate that the cellular phone now is in a state where it appears to accept further inputs in the frame or rectangle. In the input field the first character entered is displayed so that the user can see what has been entered as the starting character of the contact to be updated or entered depending on what is chosen afterwards, see the steps 630 and 640 for the two alternative choices.

In step 620, further characters representing the contact (either updated or entered as a new contact) is to be entered in the input field so as to complete the contact information. Two options are possible for the user:

Completing, i.e. keying in manually the rest of the each of the words and digits defining the contact, e.g. the street, street number and the state where the contact is situated, which words and digits are needed to obtain a full set of contact information.

Some kind of clever predictive text application, e.g. t9 or xt9, completes automatically each of the words or numbers after a few characters and digits of each of the respective words and numbers have been entered by the user and thereafter presents a proposal or proposals for words and numbers to be selected and thus actually entered as parts of the contact.

Accordingly, the cellular phone now holds and displays a complete contact information in the input field.

In step 630 and 640, the user invokes, i.e. starts or launches one of two contacts applications, respectively: i.e. either as an application for the contact to be updated or as an application for entering a new contact. The one of two contacts applications may be chosen, e.g. by a menu or an option selection.

The actually chosen contacts application uses the full set of contact information as the input parameters to the chosen contacts application. The full set of contact information are the characters actually entered into the input field and thus acts as a set of input data to the chosen contacts application prior to its launch, start or invocation.

Since the characters, letters and digits received in the input field may vary and may be entered in various ways and may be the set of GPS coordinates to navigate to, the postal address, the phone number, the contact information or the words of a SMS message, then the data entered and received of course could be alphanumeric characters, such as alphabetic characters and/or digits.

As discussed a predictive text application might be applied to limit the number of keystrokes when e.g. an address is to be entered on an ITU keyboard.

For the following example it is the aim of the user to enter the following data:

12778 Scripps Summit Drive

92131

USA

If a normal way of entering the data by means of the few keys of an ITU keyboard 63 keystrokes would be required, i.e.

Five key strokes for 12778, namely the keys 12778 which keys represent 5 keystrokes, since no additional keystrokes are needed for digits.

For ‘Scripps Summit Drive’ the following keys need be pressed on the ITU keyboard: 777722277744477777707777886644480377744488833, i.e. 46 keystrokes.

For the zip code, i.e. 92131, five keystrokes, namely the exact same five keys 92131, is required, and for the string ‘USA’ the keys 8877772 need be pressed on the ITU keyboard. Thus the address 12778 Scripps Summit Drive 92131 USA” requires a total of 63 keys to be pressed on the ITU keyboard.

From the above example it is clear that a more efficient way of entering an address would be convenient for a user. An embodiment of the invention shows how the applicant implements a predictive text application.

Assume now that 12778 Scripps Summit Drive

92131

USA

is to be entered:

Based on the entered or confirmed country and zip/postal code or country and city and state, if such is available, a list of 440 street names for zip code 92131, USA is presented below:

ABBY WOOD, ACCRA, AFFINITY, ALBANY, ALBURY, ALDERBRANCH, ALDERCREST, ALDERHILL, ALDERIDGE, ALMOND ORCHARD, AMBERSTONE, ANCONA, ANGELIQUE,

ANN ARBOR, APPALOOSA,APPLEWOOD,APRICA,ARBOR PARK,

ARBORETUM,ARBORLAKE,ARBORSIDE,ARCHSTONE,ASH REEK,ASHLAR,ASHLOCK,ASPENDELL,ATRIUM,ATWOOD,AVENUE OF ATIONS,AVIARY,AVONETTE,BACARA,BALLYSTOCK,BARRYWOOD,BEEH FERN,BELLA ROSA,BELLADONNA,BIG CANYON,BIRCH BLUFF,BIRCH LEN,BLUE CYPRESS,BLUE DIAMOND,BLUE SUMMIT, BLUET,BLUFF,BONJON,BOULDER RIDGE, BOURBON,BRACKEN ERN, BRECKENRIDGE,BRIARCLIFF, BRIGHTON RIDGE,BROOKSIDE,BROOKTREE,BROOKVIEW,BRUCKART,

BUSINESSPARK,CALCATERRA,CAMDEN,CAMINITO AGADIR,CAMINITO ALEGRACAMINITO ALTO,CAMINITO ARALIA,CAMINITO ARBOLES, CAMINITO ARCADA,CAMINITO ARMIDA,CAMINITO BANYON,CAMINITO BASSWOOD,CAMINITO BRIOSO,CAMINITO CALOR,CAMINITO CANELO,CAMINITO CANON,CAMINITO CEREZO,CAMINITO CHIRIMOLLA,CAMINITO COLORADO,CAMINITO COVEWOOD,CAMINITO CUESTA,CAMINITO DOHA,CAMINITO DULCE,CAMINITO ELADO,CAMINITO ENCANTO,

CAMINITO FESTIVO,CAMINITO GARCIA,CAMINITO GOMA,

CAMINITO GUSTO,CAMINITO JOVEN,CAMINITO LASWANE,

CAMINITO MAGNIFICA,CAMINITO MAGUEY,CAMINITO MARLOCK,

CAMINITO MAYTEN,CAMINITO MEMOSAC,CAMINITO MIRADA,

CAMINITO MOJADO,CAMINITO MUNOZ,CAMINITO NUEZ,

CAMINITO PELON,CAMINITO PERAL,CAMINITO PITAYA,

CAMINITO PRENTICIA,CAMINITO PUDREGAL,CAMINITO RIO BRANCO,CAMINITO ROGELIO,CAMINITO SANUDO,CAMINITO SERENO,

CAMINITO SOPADILLA,CAMINITO SUELTO,CAMINITO SURABAYA,

CAMINITO TAMBORREL,CAMINITO TIERRA,CAMINITO TOMATILLO,CAMINITO TORONJO,CAMINITO VANTANA,

CAMINITO VIBRANTE,CAMINITO VISTA PACIFICA,CAMINITO VISTA SERENA,CANARYWOOD,CANDY ROSE,CANTRENC,

CANYON LAKE,CARILLON,CAROWIND,CARROLL CANYON,

CASPIAN,CASSINI,CASSOWARY,CHAFFINCH,CHAPARAL VALLEY,CHARBONO,CHARDONNAY,CHARMAINE,CLARET,

CLARIDGE,CLEARWOOD,CLOVERFIELD,COBBLE CREEK,

COHANSEY,CONNELL,CORDELIA,CORRIDOR,CORTINA,

COURTYARD,CREEKSIDE,CROSSCREEK,CRYSTAL OAKS,

CUMMINS,CYPRESS CANYON,CYPRESS CANYON PARK,CYPRESS TERRACE,CYPRESS VALLEY,CYPRESS WOODS,DAYMARK,DEAR CANYON,

DEERFOOT,DEPRISE,DICHONDRA,DOVERHILL,DOWNING,

EAsTGLEN,EASTRIDGE,EASTVIEW,EASTWIND,EDEN MILLS,

EDENOAKS,EDGEWOOD,EGLANTINE,ELDERWOOD,

ELEONORE,ELK GROVE,ELMSTONE,ELWELL,ENID,

ERMA,ESPINOSA,EVERGOLD,FAIRBROOK,FALCON RIM,

FANTASIA,FIDELIO,FIGTREE,FORESTVIEW,FORTINO,FRANK DANIELS,FRONSAC,GANTNER,GATEMOORE,GINSTAR.GLENCREEK,

GOLDEN BIRCH,GRAINWOOD,GRAPE FERN,GRAYFOX,

GREEN VALLEY,GREENSTONE,GUMBARK,HALL MEADOW,

HANDRICH,HASBROOK,HEARTWOOD,HELMER,HIBERT,HIDEAWAY.HOLLY FERN,HOVLAND,IRONWOOD,IVY

HILL,JAGUAR,JEPSON,JERABACK,KEMAH,KINGSPINE,LA COLINA,LA ENTANA,LA VITA,LADY FERN,LAKE GROVE,LAKECREST,LAKERIM,LARMIER,LEAFWOOD,LEGACY,LEGACY CANYON,LES ARBRES,LES FLEURS,LIBELLE,LINDLEY,LITTLE SILVER, LIVEWOOD, LOIRE, LONGDALE, LUXEMBOURG, MAGNIFICA, MAHOGANY, MAND RAKE,MAPLE LEAF,MAPLEGROVE,MARGINATA,

MAROON PEAK,MAYAPPLE,MAYWIND,MCBURNEY RIDGE,

MCDOWELL,MCKINNEY,MEADOWDALE,MEADOWVIEW,

MEANLEY,MEDOC,MELTON,MERRITAGE,MESA MADERA,

MESA VISTA,MIRA LAGO,MIRA MESA,MIRAMAR DAM,

MIRO,MISSION PRESERVE,MISTY BLUE,MONTAUBON,

MONTBURY,MOSELLE,MOUNTAIN GLEN, MULGRAVE,

MUNDIAL,NEGLEY,NIKITA,NORMANTON,NORTHWICK,

OAK FERN,OAKBEND,OAKFORT,OLD CREEK

OLD GROVE,OLIVE KNOLL,PATINA,PEPPERBROOK,

PEPPERVIEW,PETENWELL,PICKFORD,PINE FALLSPINECASTLE,PINECLIFFS,PINEHURST,PINETREE,PINOT NOIR,POCHARD,POCHE,POINSETT,POINTED OAK,

POMERADO,PORCELINA,POYNTELL,PUNTA DULCINA,

QUAIL SPRINGS,QUINALT,RAEDENE,RAMSDELL,

RANCH VIEW,RASCON,RAVENSTHORPE,RED CEDAR,RED FERN,RED ROCK,REDCLIFF,RIDGE RUN,RIDGEWATER,RIESLING,

RINGDOVE,RITTER,ROCK CREEK,ROOKWOOD,

ROSE GARDEN,ROUGEMONT,ROXBORO,RUE BIARRITZ,

RUE CANNES,RUE CHAMBERRY,RUE CHAMONIX,

RUE CHANTEMAR,RUE CHEAUMONT,RUE DES AMIS,

RUE DU NUAGE,RUE FINISTERRE,RUE FONTENAY,

RUE FOUNTAINBLEAU,RUE MARABELLE,RUE MONT GRENOBLE,

RUE MONTEREAU,RUE PARC,RUE RIVIERE VERTE,

RUE SAINT JACQUES,RUE SAINT LAZARE,

RUE SIENNE NORD,RUE TOURAINE,RUE VINCENNES,

SAINT MORITZ,SAINT PIERRE,SANTA BRISA,SANTA PRADERA,

SANTA VIENTA,SARDIS,SAUNDERS,SAUTERNE,SCRIPPS,

SCRIPPS CAPE VISTA,SCRIPPS CREEK,SCRIPPS GATEWAY,

SCRIPPS HIGHLAND,SCRIPPS LAKE,SCRIPPS POWAY,

SCRIPPS RANCH,SCRIPPS SUMMIT,SCRIPPS VISTA,

SCRIPPS WESTVIEW,SEMILLON,SHADETREE,SHERRARD,

SIERRA CREST,SILVER OAK,SILVER RIDGE,SOUTHERN PINE,

SOUTHRIDGE,SPENCERPORT,SPOONER,SPRING CANYON,

SPRUCE GROVE,SPRUCE RUN,STARWOOD,STOCKWOOD,

STONEBRIDGE,STONECROFT,STONEDALE,STONEMONT,

STONY RIDGE,SUMMERWOOD,SUN RAY,SUNSET RIDGE,

SUNSHINE PEAK,SWAN CANYON,SWAN LAKE,SWANSON,

SWEET WILLOW,SWEETBRIAR,SYCAMORE RIDGE,TAMPERE,

TERREBONNE,THORNBUSH,TIMBERLAKE,TIMBERLINE,

TIMSFORD,TIPPERARY,TONDINO,TRAIL CREST,TREEHAVEN,

TREENA,TREEVIEW,TREYBURN,TRIBUNA,TRILLIUM,TUDOR,

TURRET,TWINLEAF,VAIL,VANDEMEN,VIA CIMBORIO,

VILLAGE RIDGE,VISTA ELEVADA,VISTA LA CUESTA,

VISTA LAGO,VISTA VALLE,WALDGROVE,WALDORF,

WALKING FERN,WALNUTDALE,WANNACUT,WATERTON,

WATKINS,WEATHERHILL,WEATHERWOOD,WELLSONA.

WESTLY.WESTWARD.WEXFORD.WHEATLAND.WHISPERING RIDGE.WHITE BIRCH,WIDE VALLEY,WILD GRAPE,WILD MEADOW,

WILDLIFE,WILLAPA,WILLOW CREEK,WILLS CREEK,

WINCHECK,WINDBROOK,WINDING RIDGE,WINDOM PEAK,WOODCHUCK,WOODCRAFT,WOODSTREAM and

ZIRBEL

The addresses may be known for several reasons such as: the address has been entered previously; the mobile terminal is connected to a database either an internal/local database or an external database accessible over, for instance, the Internet.

By tapping on the 7 key, which has the letter choices ‘p’, ‘q’, ‘r’ and ‘s’, the following list is limited to 110 possible choices, where the street names beginning with the character ‘p’, ‘q’, ‘r’ or ‘s’ are presented.

PATINA,PEPPERBROOK,PEPPERVIEW,PETENWELL,

PICKFORD,PINE FALLS,PINECASTLE,PINECLIFFS

PINEHURST,PINETREE,PINOT NOIR,

POCHARD,POCHE,POINSETT,POINTED OAK,POMERADO,

PORCELINA,POYNTELL,PUNTA DULCINA,

QUAIL SPRINGS,

QUINALT,

RAEDENE,RAMSDELL,RANCH VIEW,RASCON,

RAVENSTHORPE,RED CEDAR,RED FERN,RED ROCK,

REDCLIFF,RIDGE RUN,RIDGEWATER,RIESLING,

RINGDOVE,RITTER,ROCK CREEK,ROOKWOOD,

ROSE GARDENROUGEMONT,ROXBORO,RUE BIARRITZ,

RUE CANNES,RUE CHAMBERRY,RUE CHAMONIX,

RUE CHANTEMAR,RUE CHEAUMONT,RUE DES AMIS,

RUE DU NUAGE,RUE FINISTERRE,RUE FONTENAY,

RUE FOUNTAINBLEAU,RUE MARABELLE,RUE MONT GRENOBLE,

RUE MONTEREAU,RUE PARC,RUE RIVIERE VERTE,

RUE SAINT JACQUES,RUE SAINT LAZARE,

RUE SIENNE NORD,RUE TOURAINE,RUE VINCENNES,

SAINT MORITZ,SAINT PIERRE,SANTA BRISA,

SANTA PRADERA,SANTA VIENTA,SARDIS,SAUNDERS,

SAUTERNE,SCRIPPS,SCRIPPS CAPE VISTA,SCRIPPS CREEK,

SCRIPPS GATEWAY,SCRIPPS HIGHLAND,SCRIPPS LAKE,SCRIPPS POWAY,SCRIPPS RANCH,SCRIPPS SUMMIT,SCRIPPS VISTA,SCRIPPS WESTVIEW,SEMILLON,SHADETREE,SHERRARD,

SIERRA CREST,SILVER OAK,SILVER RIDGE,SOUTHERN PINE,

SOUTHRIDGE,SPENCERPORT,SPOONER,SPRING CANYON,

SPRUCE GROVE,SPRUCE RUN,STARWOOD,STOCKWOOD,

STONEBRIDGE,STONECROFT,STONEDALE,STONEMONT,

STONY RIDGE,SUMMERWOOD,SUN RAY,SUNSET RIDGE,

SUNSHINE PEAK,SWAN CANYON,SWAN LAKE,SWANSON,

SWEET WILLOW,SWEETBRIAR and SYCAMORE RIDGE.

By tapping on the ‘2’ key once all the following combinations of the letters on the ‘7’ key and the ‘2’ key are available:

Pa

pb -

### N/A

pc -

### N/A

qa -

### N/A

qb -

### N/A

qc -

### N/A

Ra

rb -

### N/A

rc -

### N/A

Sa

sb -

### N/A

Sc

This results in the following list of 25 street names.

PATINA,

RAEDENE,RAMSDELL,RANCH VIEW,RASCON,

RAVENSTHORPE,

SAINT MORITZ,SAINT PIERRE,

SANTA BRISA,SANTA PRADERA,SANTA VIENTA,

SARDIS,SAUNDERS,SAUTERNE,SCRIPPS,

SCRIPPS CAPE VISTA,SCRIPPS CREEK,

SCRIPPS GATEWAY,SCRIPPS HIGHLAND,

SCRIPPS LAKE,SCRIPPS POWAY,SCRIPPS RANCH,

SCRIPPS SUMMIT,SCRIPPS VISTA and

SCRIPPS WESTVIEW,

By tapping on the 7 another time a further character is added and the following combinations of the letters on the ‘7’ key and the ‘2’ key and the ‘7’ key are available:

pap -

### N/A

paq -

### N/A

par -

### N/A

pas -

### N/A

rap -

### N/A

raq -

### N/A

rar -

### N/A

ras

sap -

### N/A

saq -

### N/A

sar

sas -

### N/A

scp -

### N/A

scq -

### N/A

scr

scs -

### N/A

This results in the following list of 13 street names.

RASCON,

SARDIS,SCRIPPS,SCRIPPS CAPE VISTA,

SCRIPPS CREEK,SCRIPPS GATEWAY,SCRIPPS HIGHLAND,

SCRIPPS LAKE,SCRIPPS POWAY,SCRIPPS RANCH,

SCRIPPS SUMMIT,SCRIPPS VISTA and

SCRIPPS WESTVIEW

By tapping on the ‘4’ containing the letters ‘g’ ‘h’ and ‘i’ the list is narrowed down to these possibilities:

rasg -

### N/A

rash -

### N/A

rasi -

### N/A

sarg -

### N/A

sarh -

### N/A

sari -

### N/A

scrg -

### N/A

scrh -

### N/A

scri

This results in the following list of 11 street names

SCRIPPS,SCRIPPS CAPE VISTA,SCRIPPS CREEK,

SCRIPPS GATEWAY,SCRIPPS HIGHLAND,

SCRIPPS LAKE,SCRIPPS POWAY,SCRIPPS RANCH,

SCRIPPS SUMMIT, SCRIPPS VISTA and

SCRIPPS WESTVIEW

By now tapping the ‘0’ key to obtain a space character, the list is now reduced to 10 choices:

SCRIPPS CAPE VISTA,SCRIPPS CREEK,SCRIPPS GATEWAY,

SCRIPPS HIGHLAND,SCRIPPS LAKE,SCRIPPS POWAY,

SCRIPPS RANCH,SCRIPPS SUMMIT,SCRIPPS VISTA and

SCRIPPS WESTVIEW.

By tapping on the ‘7’ key the street names containing “Scripps+space+‘p’, ‘q’, ‘r’, or ‘s’” are presented:

SCRIPPS POWAY, SCRIPPS RANCH and SCRIPPS SUMMIT

And finally by tapping on the ‘8’ key containing the letters ‘t’, ‘u’ and ‘v’ once, only one street name remains: SCRIPPS SUMMIT

Subsequently the number may be entered and the entering of the complete address is obtained through only 17 key presses instead of 63 key presses. That is: 0 key presses for the country as this may be set as default or detected based on e.g. carrier, GPS location or clock settings, entering of the zip code is achieved in 5 key presses, the street name in 7 key presses and finally the number on the street, 5 key presses.

The way the predictive text application may be implemented is e.g. when the user enters an address in any application, such as an address in a SMS application, a contact application, a navigational application, a notepad application, a word processor application and e-mail, etc. When the address is written starting with ZIP code the predictive text application automatically performs a look up in database, e.g. in a table, accessible either locally (i.e. within the mobile terminal) or by means of a communication network, such as the Internet, etc. As a result of the look up all street names associated with the ZIP code are available in a similar way as indicated in the example above where the address SCRIPPS SUMMIT was found.

Although the disclosed embodiments have above been described using an embodiment in a mobile terminal and a user interface, the disclosed embodiments are applicable to any type of portable apparatus, such as cellular or mobile phones capable of presenting alerts, including pocket computers, portable mp3-players, portable gaming devices, cameras, lap-top computers, desktop computers, GPS devices, etc.

The disclosed embodiments have mainly been described above with reference to a few embodiments, such as three specific applications. However, as is readily appreciated by a person skilled in the art, other embodiments than the ones disclosed above are equally possible within the scope of the disclosed embodiments, as defined by the appended patent claims. Thus other application requiring textual and digital input—apart from those three mentioned—invoked from the idle state display mode of the cellular phone are also within the scope of the disclosed embodiments and covered by the appended patent claims.

1. A method of performing input to an application comprising:
receiving in a display being in an idle state display mode a first character of an information item associated with the application and displaying an input field and said first character in said input field on said display in response to said received first character,
receiving more characters to said input field said received more characters following said received first character so as to complete said information item,
invoking the application using said completed information item as an input parameter to the application, wherein said application is selected from a group comprising a navigation application, an application for adding or updating contacts who can be phoned, an application for sending SMS, and an application applying a letter in said completed information item.

2. The method according to claim 1, said completed information item selected from the group of a phone number, a set of GPS coordinates, a contact information, an address or a phone number included in a SMS message and a postal address of the location to navigate to, when said application being a navigation application.

3. The method according to claim 1, said completed information item being a contact information such as a name and a phone number of a contact and when said application being an application for adding or updating contacts who can be phoned.

4. The method according to claim 1, said completed information item being a SMS message when said application being an application for sending SMS.

5. The method according to claim 1 wherein the characters received are handled by a predictive text application so as to complete said information item before all characters comprised in the complete information item are received.

6. The method according to claim 5, said predictive text application being selected from the group of t9 and xt9.

7. The method according to claim 1, said characters received from an ITU keyboard.

8. The method according to claim 1 wherein the characters received are transferred from another application.

9. A method according to claim 8 wherein the action of transferring comprising the step of cutting and pasting a text from another application.

10. A method according to claim 8 wherein the action of transferring comprising the step of copying and pasting text from another application.

11. A mobile terminal for performing input to an application comprising:
an application handler for handling said application,
a display in an idle state display mode,
a man-machine interface for receiving a first character of an information item associated with the application while said display is an idle state display mode,
the display for displaying an input field and said first character in said input field in response to said received first character,
said input field for receiving more characters following said first character from said man machine interface, said received more characters following said received first character so as to complete said information item,
said application handler for invoking the application using said completed information item as an input parameter to the application, wherein said application is selected from a group comprising a navigation application, an application for adding or updating contacts who can be phoned, an application for sending SMS, and an application applying a letter in said completed information item.

12. The mobile terminal according to claim 11, said completed information item selected from the group of a phone number, a set of GPS coordinates, a contact information, an address or a phone number included in a SMS message and a postal address of the location to navigate to, when said application being a navigation application.

13. The mobile terminal according to claim 11, said completed information item being a contact information such as a name and a phone number of a contact when said application being an application for adding or updating contacts who can be phoned.

14. The mobile terminal according to claim 11, said completed information item being a SMS message when said application being an application for sending SMS.

15. The mobile terminal according to claim 11, said received characters being handled by a predictive text application for completing said information item before all characters comprised in the complete information item are received.

16. The mobile terminal according to claim 15, said predictive text application being selected from the group of t9 and xt9.

17. The mobile terminal according to claim 11, said man-machine interface comprising an ITU keyboard for receiving said characters.

18. The mobile terminal according to claim 11, said received characters being transferred from another application.

19. The mobile terminal according to claim 18, said action of transferring comprising the step of cutting and pasting a text from another application.

20. The mobile terminal according to claim 18, said action of transferring comprising copying and pasting text from another application.

21. A user interface for performing input to an application comprising:
an application handler for handling said application,
a display in an idle state display mode,
a man-machine interface for receiving a first character of an information item associated with the application while said display is an idle state display mode,
the display for displaying an input field and said first character in said input field in response to said received first character,
said input field for receiving more characters following said first character from said man machine interface, said received more characters following said received first character so as to complete said information item, and
said application handler for invoking the application using said completed information item as an input parameter to the application, wherein said application is selected from a group comprising a navigation application, an application for adding or updating contacts who can be phoned, an application for sending SMS, and an application applying a letter in said completed information item.

22. The user interface according to claim 21, said completed information item selected from the group of a phone number, a set of GPS coordinates, a contact information, an address or a phone number included in a SMS message and a postal address of the location to navigate to, when said application being a navigation application.

23. The user interface according to claim 21, said completed information item being a contact information such as a name and a phone number of a contact when said application being an application for adding or updating contacts who can be phoned.

24. The user interface according to claim 21, said completed information item being a SMS message when said application being an application for sending SMS'es.

25. The user interface according to claim 21, said received characters being handled by a predictive text application for completing said information item before all characters comprised in the complete information item are received.

26. The user interface according to claim 25, said predictive text application being selected from the group of t9 and xt9.

27. The user interface according to claim 21, said man-machine interface comprising an ITU keyboard for receiving said characters.

28. The user interface according to claim 21, said received characters being transferred from another application.

29. The user interface according to claim 28, said action of transferring comprising the step of cutting and pasting a text from another application.

30. The user interface according to claim 28, said action of transferring comprising copying and pasting text from another application.

31. A computer program product stored in a memory comprising software instructions that, when executed in a controller of a mobile terminal, performs the method according to claim 1.
